(19) United States
(12) Patent Application Publication
(10) Pub. No.: US 2006/0003054 A1
(43) Pub. Date: Jan. 5, 2006

(54) Croissants and method for forming same

(76) Inventors: Douglas L. Goedeken, Blaine, MN (US); Rosebud L. Sierzant, Minneapolis, MN (US); Alan A. Oppenheimer, Savage, MN (US)

Correspondence Address: GENERAL MILLS, INC., P.O. BOX 1113, MINNEAPOLIS, MN, 55440, US

(21) Appl. No.: 11/157,440

(22) Filed: Jun. 21, 2005

Related U.S. Application Data
(60) Provisional application No. 60/581,498, filed on Jun. 21, 2004.

(51) Int. Cl. A23G 3/00

(52) U.S. Cl. 426/94

(57) ABSTRACT

A croissant intermediate having a stress-relieving feature such that the croissant intermediate does not become unpinched during baking. The stress-relieving feature can take the form of a cut, either completely through or partially through a thickness of the croissant intermediate, within a triangular croissant intermediate that is substantially perpendicular to a leading edge and does not intersect either the leading edge or a pair of side edges. The cut can be made, either manually or automatically, and is generally made at the same time as the triangular croissant intermediate is cut from a sheet of croissant dough. The stress-relieving feature may comprise one or more cuts within the croissant intermediate.

### REFERENCE TO RELATED APPLICATIONS

This application claims the benefit of priority under 35 U.S.C. § 119(e)(1) of a provisional patent application, Ser. No. 60/581,498, filed Jun. 21, 2004, which is incorporated herein by reference in its entirety.

### FIELD OF THE INVENTION

The invention relates to croissants and a method for forming cut dough into croissants. Specifically, the invention relates to forming croissant intermediates such that the croissant retains its shape during baking.

### BACKGROUND

Croissants are a popular, layered pastry that are shaped and baked in a familiar, crescent shape. Croissants are specifically named after their crescent shape in French, wherein croissant in French means “crescent.” The dough used in making croissants is cut to form a croissant intermediate, which is subsequently wrapped and pinched to form a crescent-shape croissant intermediate. The dough is proofed or caused to rise by using yeast to break down simple sugars present within the dough into carbon dioxide and alcohol. During baking or proofing, the yeast may initially cause the croissant dough to continue rising wherein the traditional crescent shape of the croissant intermediate may be lost or deformed. The loss of the crescent shape during baking can lead to a visually unacceptable croissant. As such, it would be advantageous to have croissant intermediates that did not deform or change shape during baking.

### SUMMARY

The invention addresses the aforementioned need by providing a croissant intermediate having a stress-relieving feature such that the croissant intermediate does not come unpinched during baking. The stress-relieving feature generally takes the form of at least one cut within a triangular croissant intermediate that is substantially perpendicular to a leading edge and does not intersect either the leading edge or a pair of side edges. The cut can be made, either manually or automatically, and is generally made at the same time as the triangular croissant intermediate is formed from croissant dough. The stress-relieving feature may comprise one or more cuts within the croissant intermediate.

In one aspect, an embodiment of the invention comprises a croissant intermediate having a stress-relieving feature that serves to prevent a pinched croissant intermediate from coming unpinched during baking.

In another aspect, the invention comprises a process for forming a croissant intermediate having an integral stress-relieving feature.

The above summary of the various embodiments of the invention is not intended to describe each illustrated embodiment or every implementation of the invention. The Figures in the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a top view of an embodiment of a croissant intermediate.

FIG. 2 is a perspective view of croissant intermediate of FIG. 1.

FIG. 3 is a top view of a rolled, elongated croissant intermediate.

FIG. 4 is a top view of a rolled and pinched croissant intermediate.

FIG. 5 is a top view of an embodiment of an improved croissant intermediate of the invention.

FIG. 6 is a top view of an improved rolled, elongated croissant intermediate.

FIG. 7 is a top view of an improved rolled and pinched croissant intermediate.

FIG. 8 is a top view of an embodiment of an improved croissant intermediate.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

As used herein, the term “croissant intermediate” refers to an article that is in an intermediate condition and requires further thermal processing such as baking, cooking or frying to change the intermediate into a croissant suitable for consumption by a consumer.

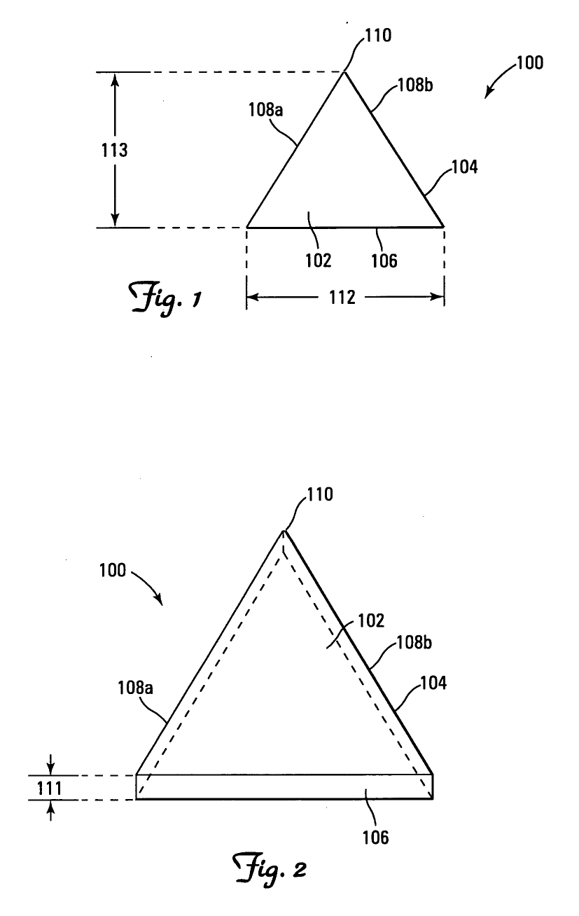

A known croissant intermediate 100 is illustrated in FIGS. 1 and 2. Generally, croissant intermediate 100 is made from a piece of croissant dough 102 that has been cut to form a triangular shape 104. Triangular shape 104 is generally defined by a base or leading edge 106 and a pair of side edges 108a, 108b. A tail 110 is defined at the intersection of side edges 108a, 108b opposite of leading edge 106. Croissant intermediate 100 has an intermediate thickness 111 that can vary from approximately 4 mm to approximately 10 mm. In a representative embodiment, croissant intermediate 100 has a leading edge length 112 which can be, for example, 10 cm to about 20 cm, and an intermediate height 113 which can be, for example, 8 cm to 15 cm. In one embodiment, a smaller sized product can be about 11 cm (leading edge length) by 9 cm (intermediate height). In another embodiment, a large croissant can have a leading edge length of about 19 cm and an intermediate height of about 13 cm.

Croissant dough 102 is generally formulated to be a highly developed dough having many layers upon baking. In one representative example, croissant dough 102 may have a composition, expressed in weight percent, as follows:

| Ingredient | Wt. % |
|---|---|
| Milk | 24% |
| Yeast | 2% |
| Flour | 41.5% |
| Salt | 1.5% |
| Sugar | 3% |
| Butter | 28% |

Croissants can generally be made from a variety of dry ingredients including but not limited to, flour, sugar, yeast, and salt; as well as liquids such as water, milk, and combinations thereof; and a fat source such as margarine, shortening, butter, or some combinations thereof. Typically, croissants dough compositions can include wheat flour at 30 wt %-50 wt %, water or milk at 0 wt % to 24 wt %, a fat source(s) at 0 wt %-35 wt %, salt at 0.5 wt %-1.0 wt %, sugar at 1 wt %-8 wt %, and yeast at 1 wt % to 6 wt %. Optionally, added flavors and other ingredients can be added to change the flavor of a croissant. For example, ingredients & components such as the following can be added alone or in combination: ascorbic acid, azodicarbonimide molasses, non-fat dry milk, whole milk, honey, butter flavor, vital wheat gluten, whole wheat flour, and cracked wheat.

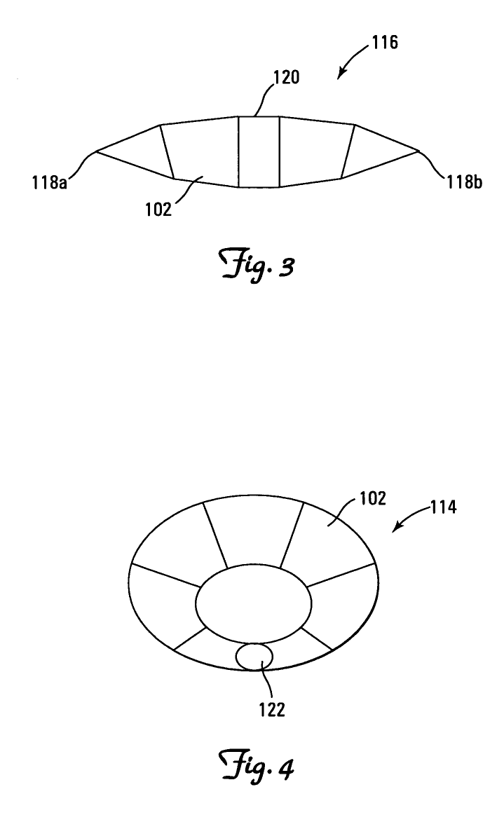

Croissant dough 102 is typically rolled flat and cut to form the croissant intermediate 100. Croissant intermediate 100 is rolled as shown in FIG. 3 wherein the tail 110 is wrapped around the leading edge 106 to form a rolled, elongate intermediate 116. Elongate intermediate 116 is generally defined by a pair of ends 118a, 118b and an increased diameter middle portion 120. Elongated intermediate 116 is then manipulated such that ends 118a, 118b are in proximity such that ends 118a, 118b can be pinched together at a pinch point 122 resulting in the formation of a pinched croissant intermediate 114 as shown in FIG. 4. Pinched croissant intermediate 114 is then ready for storage, or proofing and baking.

Prior to baking, the pinched croissant intermediate 114 is allowed to rise or proof. During proofing, the yeast begins to break down the sugars present within croissant dough 102. As the yeast breaks down the sugars, croissant dough 102 begins to rise as carbon dioxide resulting from the consumption of the sugar causes the air pockets within the dough to stretch and expand. After proofing, the pinched croissant intermediate 114 is baked. During baking, the croissant dough 102 can experience additional expansion as the yeast can still actively convert the simple sugars into alcohol and carbon dioxide. The interior of the rolled and pinched croissant 114, either uncooked or partially cooked, eventually reaches a high enough temperature such that the yeast is no longer active. However, the expansion that occurs during baking can result in the ends 118a, 118b detaching at the pinch point 122 such that the look and appearance of pinched croissant intermediate 114 is no longer achieved. In addition to expansion related stresses related to air cell growth, highly developed doughs such as croissant dough 102 also experience gluten network related stresses which can further contribute to shape distortion during baking or proofing.

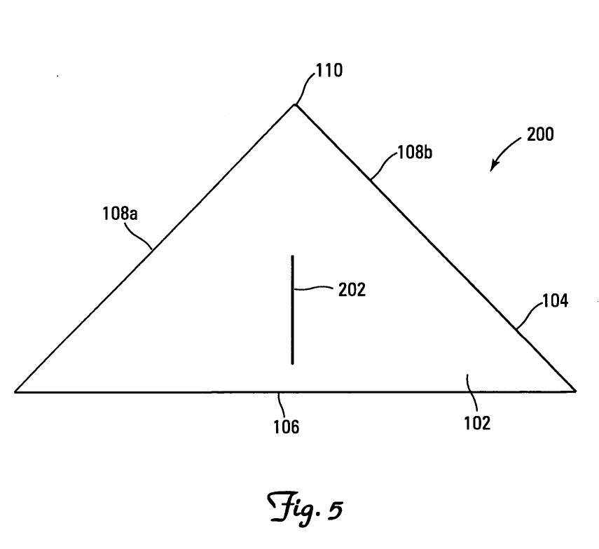

An embodiment of an improved croissant intermediate 200 is illustrated in FIG. 5. Exemplary croissant intermediate 200 includes an expansion-relieving cut 202 within the triangular shape 104. Expansion-relieving cut 202 is placed so as to be substantially perpendicular to leading edge 106. Expansion-relieving cut 202 can be made manually or automatically with a suitable cutting instrument. In one example embodiment, expansion-relieving cut 202 is made concurrently with the formation of the triangular shape 104. Expansion-relieving cut 202 can extend part way or all the way through the previously described intermediate thickness 111 shown in FIG. 2. At no point does expansion-relieving cut 202 intersect with either the leading edge 106 or the side edges 108a, 108b. Croissant intermediate 200 can have dimensions of, for example, 19 cm for the leading edge length and, for example, 11 cm for the intermediate height length, referencing FIG. 1, such that expansion-relieving cut 202 can have a length ranging from approximately 2 cm to approximately 5cm. It will be further understood that an expansion-relieving cut may be greater than 5 cm or less than 2 cm depending upon the desired dimensions of croissant intermediate 200. With respect to the length of the expansion-relieving cut 202, it is to be understood that one of the limiting factors for the length of expansion-relieving cut 202 is that the expansion-relieving cut 202 does not intersect the leading edge 106 or the tail 110 as illustrate in FIG. 1. Improved croissant intermediate 200 comprises the same croissant dough 102 as croissant intermediate 100.

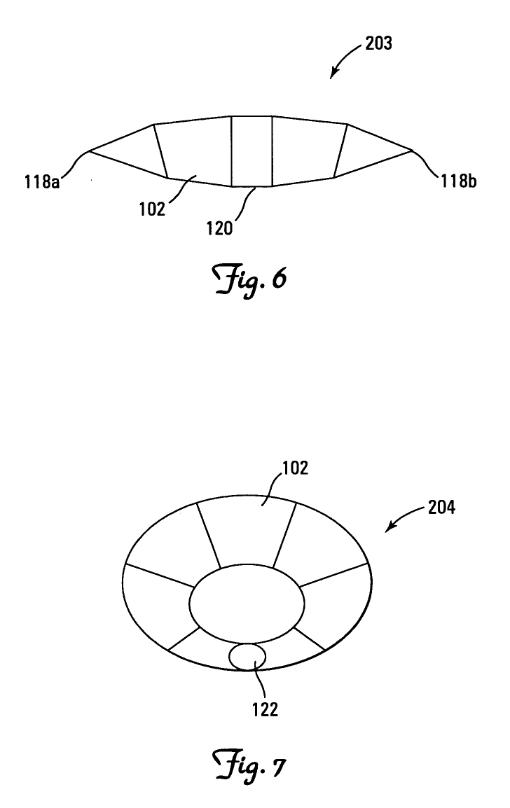

After the expansion-relieving cut 202 has been made on the croissant intermediate 200, the croissant intermediate 200 is rolled and pinched as shown in FIGS. 6 and 7 and as previously described with respect to croissant intermediate 100 in FIGS. 3 and 4. As shown in FIG. 6, croissant intermediate 200 is first rolled to form a cut elongate croissant intermediate 203 that is subsequently pinched to form a cut and pinched croissant intermediate 204 as shown in FIG. 7. During rolling of the croissant intermediate 200, the expansion-relieving cut 202 can be covered such that the expansion-relieving cut 202 is not visible from the outside. Cut and pinched croissant intermediate 204 can then be stored, and/or proofed and baked. During baking, the expansion-relieving cut 202 absorbs the expansion related stresses resulting from baking the croissant dough 102. As such, the improved rolled and pinched croissant 204 remains substantially intact in appearance, e.g. pinch point 122 as shown in FIG. 7 is maintained.

In comparing the baking results for croissant intermediate 100 versus croissant intermediate 200, it has been found that the inclusion of expansion-relieving cut 202 substantially reduces the potential for baked croissants to develop a discontinuity, particularly at pinch point 122, or having an unpinched appearance. In tests, it has been found that approximately 15-20% of the croissant intermediates 100 become unpinched during baking. By including at least one expansion relieving cut 202, the amount of baked croissants having an unpinched appearance was reduced if not eliminated.

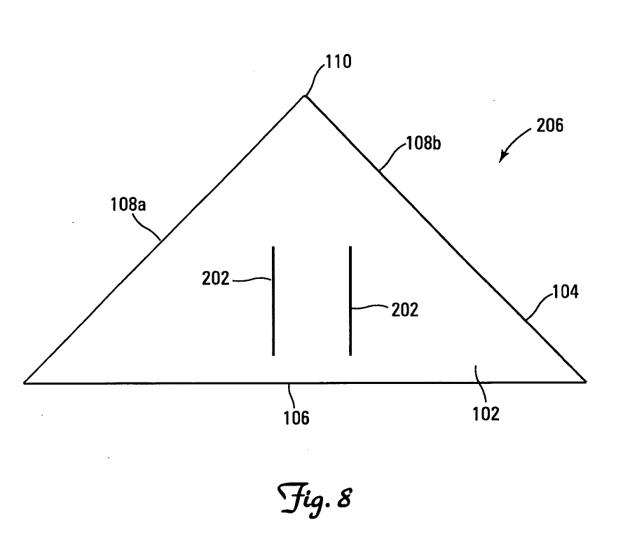

In alternative embodiments, a plurality of expansion-relieving slices 202 can be cut within croissant dough 100. For instance, an embodiment of an improved croissant intermediate 206 having two expansion-relieving cuts 202 is shown in FIG. 8. Regardless of the number of expansion-relieving cuts 202, suitable embodiments include expansion-relieving cuts 202 that are substantially perpendicular to the leading edge 106 and that stop short of intersecting the leading edge 106 and the side edges 108a, 108b.

Although various embodiments of the present invention have been disclosed here for purposes of illustration, it should be understood that a variety of changes, modifications and substitutions may be incorporated without departing from either the spirit or scope of the present invention.

What we claim:

1. A method for preparing a croissant intermediate comprising:
forming the croissant intermediate in a triangular shape defined by a leading edge and a pair of opposed edges; and
making at least one cut substantially perpendicular to the leading edge, the at least one cut being within the croissant intermediate such that the at least one cut does not intersect any of the edges of the croissant intermediate.

2. The method of claim 1, wherein forming the croissant intermediate and making the at least one cut are performed simultaneously.

3. The method of claim 1, wherein forming the croissant intermediate and making the at least one cut are performed by an automated slicing apparatus.

4. The method of claim 1, further comprising:
rolling the croissant intermediate including the at least one cut by wrapping a tail around the leading edge to form an elongated intermediate having a first end and a second end.

5. The method of claim 4, further comprising:
pinching the first end and the second end together to form a crescent-shaped intermediate.

6. The method of claim 1, wherein a plurality of cuts are made substantially perpendicular to the leading edge.

7. The method of claim 1, wherein the at least one cut extends completely through a thickness of the croissant intermediate.

8. A croissant intermediate comprising:
croissant dough portion formed in a triangular shape defined by a leading edge and a pair of opposed edges wherein the croissant dough includes at least one cut oriented substantially perpendicular to the leading edge and wherein the at least one cut does not intersect any of the edges of the croissant intermediate.

9. The croissant intermediate of claim 8, wherein the croissant dough includes a plurality of cuts oriented substantially perpendicular to the leading edge and wherein none of the plurality of cuts intersects any of the edges of the croissant intermediate.

10. The croissant intermediate of claim 8, wherein the croissant dough portion has a dough thickness between about 4 mm and about 10 mm.

11. The croissant intermediate of claim 10, wherein the at least one cut extends through the dough thickness.

12. A method for preparing a croissant comprising:
forming a croissant dough mass in a triangular shape defined by a leading edge and a pair of opposed edges and wherein at least one cut is made substantially perpendicular to the leading edge such that the at least one cut is fully contained within the croissant intermediate;
rolling the leading edge of the croissant intermediate in a direction of the at least one cut to form a rolled croissant intermediate; and
pinching a first end and a second end of the rolled croissant intermediate together to form a substantially crescent-shape croissant intermediate.

13. The method of claim 12, wherein forming the croissant dough mass is accomplished using an automated slicing apparatus.

14. The method of claim 12, further comprising:
baking the crescent-shaped croissant intermediate such that the first end and the second end remain in pinched relation.

15. The method of claim 12, wherein the croissant intermediate include a plurality of cuts positioned substantially perpendicular to the leading edge and fully contained within the crescent intermediate.
